(19) United States
(12) Patent Application Publication
(10) Pub. No.: US 2012/0263916 A1
(43) Pub. Date: Oct. 18, 2012

(54) SPORTS BOARD STRINGER SYSTEM

(76) Inventors: Robb Green, Carlsbad, CA (US); Henry Van Dyke Johns, III, Solana Beach, CA (US); Chuck Burns, Vista, CA (US); Justin Alexander Fassnacht, Santa Monica, CA (US)

(21) Appl. No.: 13/089,284

(22) Filed: Apr. 18, 2011

(51) Int. Cl. B63B 35/79; B32B 21/10; A63C 17/01; B63B 35/81; B32B 3/10; D04H 13/00; D04H 3/16

(52) U.S. Cl. 428/138; 442/327; 442/413; 442/401

(57) ABSTRACT

The presently disclosed sports board stringer system provides for a flexible, high tensile strength, waterproof structural support for any sports board. The stringer system itself comprises one or more lengths of random, non-woven, thermoplastic web fiber composite material, bonded by resin, and inserted or formed into the core of the board. In alternate embodiments, wood or other materials can make up additional layers which are also bonded to the fiber composite by resin. Additionally, stringers of the present invention can be constructed in different layouts, with more than one width of stringer section at any section of the board. Also, multiple stringers could be located in different places throughout a board. The stringer material, including all layers, can be constructed and transported in sheets and then locally cut and sanded to any length or thickness.

### FIELD OF INVENTION

The present invention relates to the field of sports boards, such as surfboards, kite boards, knee boards, windsurfing boards, skim boards, skateboards, snowboards and skis. More specifically, the invention relates to stiffening systems, spines or stringers that are placed within these boards.

### BACKGROUND OF THE INVENTION

Since the inception of surfing when ancient Polynesian used dug-out canoes to surf waves, most recreational crafts have been made of wood. Early Hawaiians managed to reduce the size of these vehicles down to mere three hundred pound longboards. Over time, the need has increased to make boards lighter and stronger, allowing surfers to make quicker and more complex maneuvers. More recently, board shapers have been touted as the gods of the sports for shaving perfect rails and rockers out of foam. This is mainly because the materials used for the boards have remained constant, leaving shape as the only variable. For decades, boards have traditionally been made of foam with a wooden stringer running down the middle for support. However, recently a change has begun to emerge in the type of materials being used.

Stringers have typically been constructed from bass wood due to its easy manipulation and construction. However, recently it has been shown that stronger boards provide more control and carve through the water better by more efficiently translating turbulent flow into laminar flow. Stronger, yet more flexible boards are also less prone to snapping, which can occur anywhere from twenty to forty times per year for active professional surfers. Some designers have caught on to this problem and begun playing with the size, location and construction of the stringers. Now, a consumer is able to purchase boards with stringers made from hardened foam, fiberglass, carbon fiber or graphite in addition to various species of wood.

For an example of shape, U.S. Pat. No. 7,435,150 discloses a stringer system which employs the use of lateral support ribs which extend from a central spine and can be spaced apart varying amounts in order to alter the flexibility. U.S. Patent Application No. 20080305697 also attempts to alter the mechanical properties of a board by adding consistent rigidity using a plurality of vertical stringers of varying lengths spaced across the board. Other ideas have focused on the properties of a single stringer itself. U.S. Pat. No. 5,944,570 suggests pre-stressing a stringer before combining it with the rest of the board. Even further back, U.S. Pat. No. 5,145,430 describes using a foam or hollow spine to provide strength to the board. U.S. Pat. No. 4,798,549 also suggests using a lightweight foam or hollow stringer possibly surrounded by an airbag. In order to add strength but keep boards lightweight, U.S. Pat. No. 7,578,254 first suggests using a fiberglass or graphite rod stringer. Others, such as U.S. Patent Application No. 20080248701, also describe using hollow fiberglass tubes and U.S. Patent Application No. 20090264034 uses a tubular carbon fiber stringer.

However, to date, no references have cited experimenting with a non-woven thermoplastic fiber for use in a board's stringer. Therefore, there exists a need to develop a high strength, elastic, and waterproof stringer that will not crack, delaminate nor be subject of potential warping after extended use. The novel stringer should have uniform properties along all axis. It will not contain any imperfections or weak spots, as found in wood, nor expand and contract due to permeation of moisture or gasses. This stringer should also be able to be quickly and easily constructed with minimal impact on tools and provide a consistent strength, yet high degree of elasticity along the entire length of a board without the need to piece it together in scarfs. The presently disclosed stringer system provides exactly such an innovation.

### SUMMARY OF THE INVENTION

The presently disclosed sports board stringer system provides for a flexible, high tensile strength, waterproof structural support for any sports board. The stringer comprises one or more lengths of random, non-woven, thermoplastic web fiber composite material, bonded by resin, and inserted into the core of the board. In alternate embodiments, wood or other materials can make up additional layers which are also bonded to the fiber composite by resin. Additionally, stringers of the present invention can be constructed in different layouts, with more than one width of stringer section at any section of the board. For example, the tail section of a board might comprise more stringer widths than the body or nose. Also, multiple stringers could be located in different places throughout a board. In another alternate embodiment, the stringer could be constructed within the board using a vacuum processing technique. The stringer material, including all layers, can be constructed and transported in sheets and then locally cut and sanded to any length or thickness.

These and other objectives of the claimed invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A illustrates a precursor product of the preferred embodiment of the present invention.

FIGS. 1B, 1C and 1D illustrate magnified views of the corner of alternate embodiments of the precursor product of the present invention shown in FIG. 1A.

FIG. 2A illustrates an alternate embodiment of the precursor product of the present invention.

FIGS. 2B and 2C illustrate magnified views of the corner of the alternate embodiment of the precursor product of the present invention shown in FIG. 2A.

FIG. 3 illustrates a layout of the preferred embodiment of the present invention.

FIG. 4 illustrates a preferred embodiment of the present invention inside a sports board in a single location.

FIG. 5 illustrates an alternate embodiment of the present invention inside a sports board in multiple locations.

### DETAILED DESCRIPTION OF THE PREFERRED EMBODIMENT

In the following description of the various embodiments, reference is made to the accompanying drawings, which form a part hereof, and in which is shown by way of illustration various embodiments in which the invention may be practiced. It is to be understood that other embodiments may still be utilized and structural and functional modifications may be made without departing from the scope and spirit of the present invention.

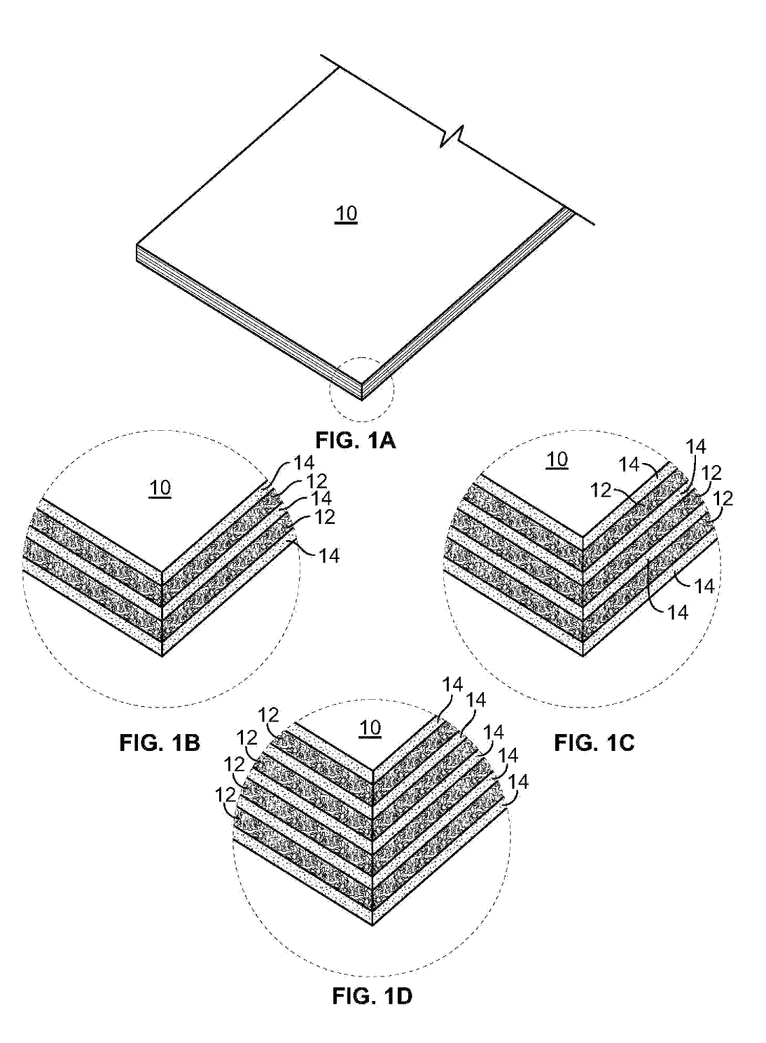

Referring to FIG. 1, a precursor product of the preferred embodiment of the present invention is shown. This cut-away view shows a sheet containing multiple layers which are defined by a particular lamination schedule. Sheet 10 can be manufactured by forming a layer of fiber composite 12, most likely using thermal bonding techniques, laying it on a lamination table and applying resin 14 to the top surface. Next, another layer of fiber composite 12 is formed and laid on top of the resin layer. This process can be repeated any number of times. During the process, resin 14 will slowly seep into composite 12, so that the composite layer will include some amount of resin 14. In the preferred method of making fiber composite 12 and sheet 10, composite 12 is formed using spunbonding, carding, wetlaying, hydroentangling or any combination of these processes. The resulting product will have a preferred weight of 10-200 grams per meter squared (g/m²), a preferred fiber diameter of 15-25 micrometers (μm), and a preferred web thickness of 0.2-1.5 millimeters (mm). This provides for a high strength to weight ratio, a high tear strength and planar isotropic properties due to a random lay down of the fibers.

As can be seen magnified in FIG. 1B, the layers are comprised of random, non-woven, thermoplastic web fiber composite 12 bonded together by resin 14. An example of this fiber composite 12 might be non-woven nylon or other polyamides. Resin 14 may be comprised of epoxy, vinylester or polyester. As can be seen in FIGS. 1B and 1C, there may be four, five or even multiple layers of composite fiber 12 bonded together to form sheet 10, which may then be cut into strips to form a stringer.

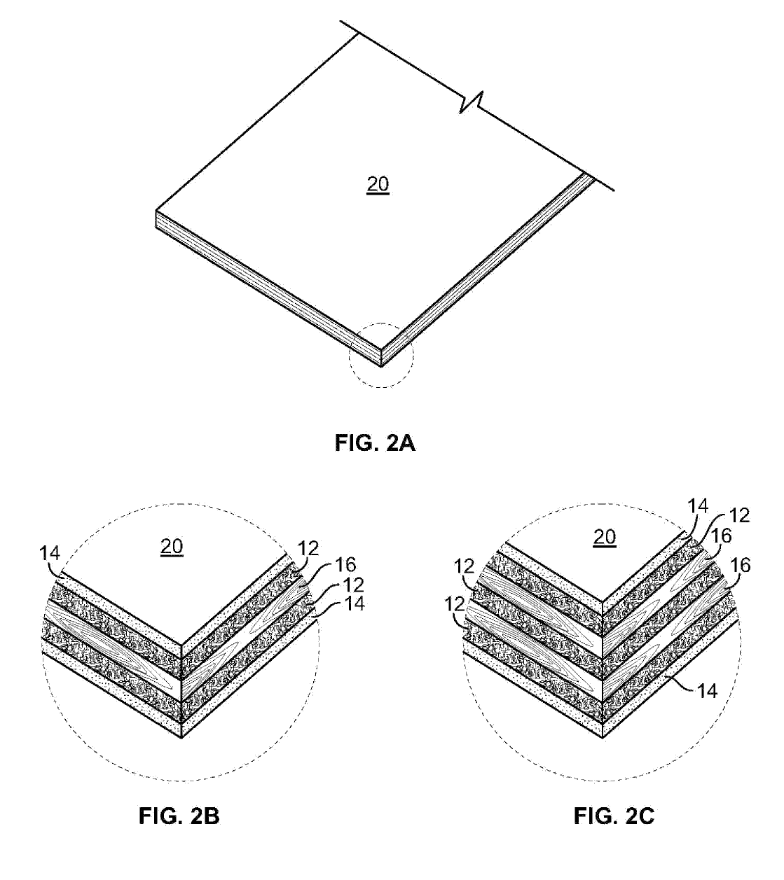

Now referring to FIG. 2A, an alternate precursor product of the present invention is shown. This cut-away view shows a stringer precursor sheet 20 again containing multiple layers, such as composite fiber 12 and resin 14, as in FIG. 1A, except now an additional material 16, such as wood, is laminated between the layers of composite fiber 12. The type of wood may include those used in traditional stringers such as balsa and basswood. Additional material 16 may also be comprised of one or more alternate natural or artificial materials. Also the wood or additional material 16 may be intertwined uniformly or in various patterns within sheet 20. As can be seen magnified in FIGS. 2B and 2C, there may be layers of composite fiber 12 surrounding a single layer of additional material 16 or surrounding two or more layers of additional material 16. Furthermore, composite fiber 12 may surround or be interspersed within the layers of additional material 16 to form sheet 20.

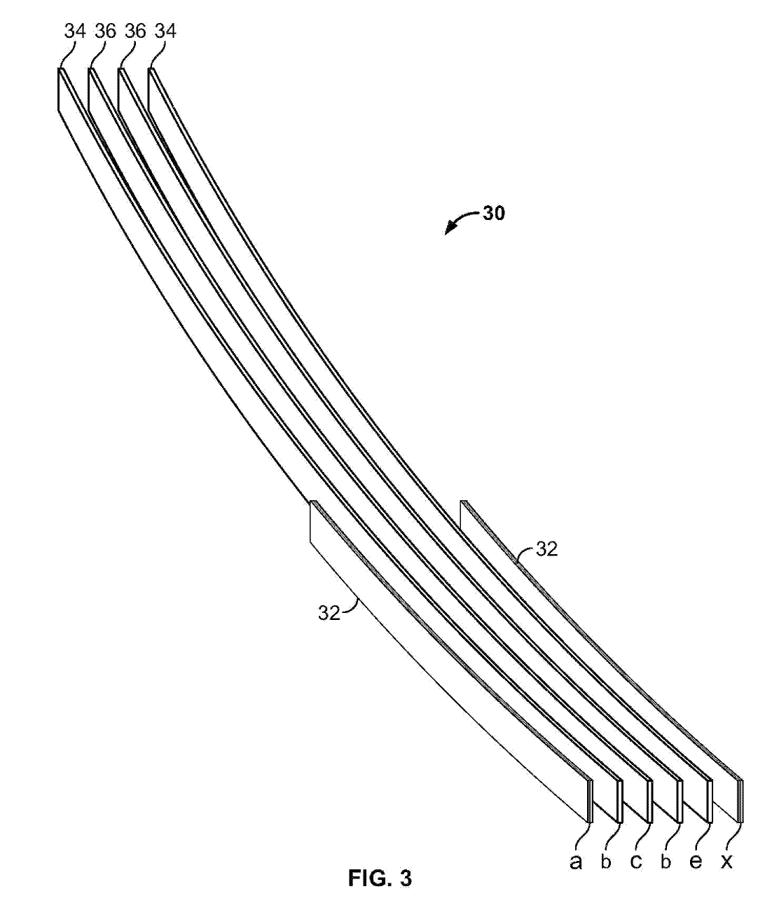

Now referring to FIG. 3, a layout of the preferred embodiment of the present invention is shown. Stringer system layout 30 comprises several lengths of stringer a-x, that similar to the layers within each stringer, can also be bonded together at various locations of a sports board. In this preferred embodiment, full length strips 36 may be used in the center with longer length strips 34 along the sides and shorter length strips 32 in places where greater stiffness is required, such as the tail area of a board. In alternate embodiments of the present invention, any number of stringers a-x may be used in any particular stringer layout 30. It is important to recognize that even though multiple stringers are shown here to create stringer system layout 30, individual stringers can be built to span the entire longitudinal distance of even the longest board. This is only possible by using the presently disclosed novel composite material 12 and layered approach of sheets 10 and 20, whereas traditional stringers must be pieced together or overlapped lengthwise in order to achieve this result.

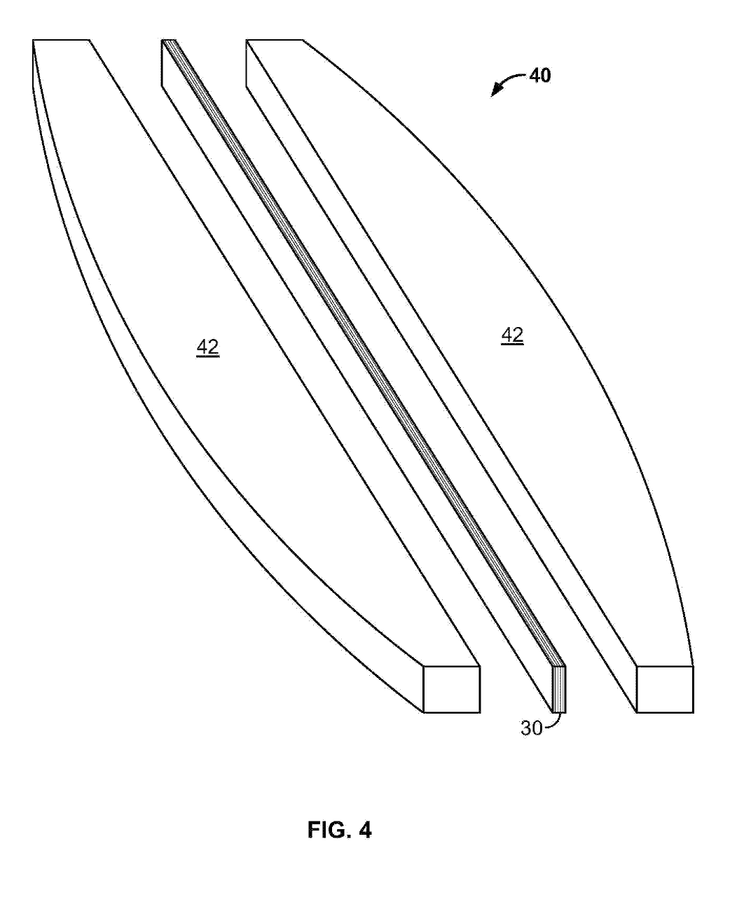

Now referring to FIG. 4, a complete sports board stringer system is shown with stringer system 30 in a single line location of the sports board. As before, stringer system 30 may have any number of various composition layers and various layouts. In this preferred embodiment, stringer 30 runs in a longitudinal direction the entire length of the board. In rare instances, it may run for a portion of the length of the board. This particular figure shows foam blank 42 cut in half around stringer system 30, which can then be glued back together with stringer system 30 in the center. Foam blank 42 is constructed of various combinations of polystyrene, polyurethane and Styrofoam®. In alternate embodiments, the presently disclosed sports board stringer system may be manufactured by constructing stringer system 30 within the board using a vacuum process technique or drilling slots in blank 42 in order to insert the stringer after shaping.

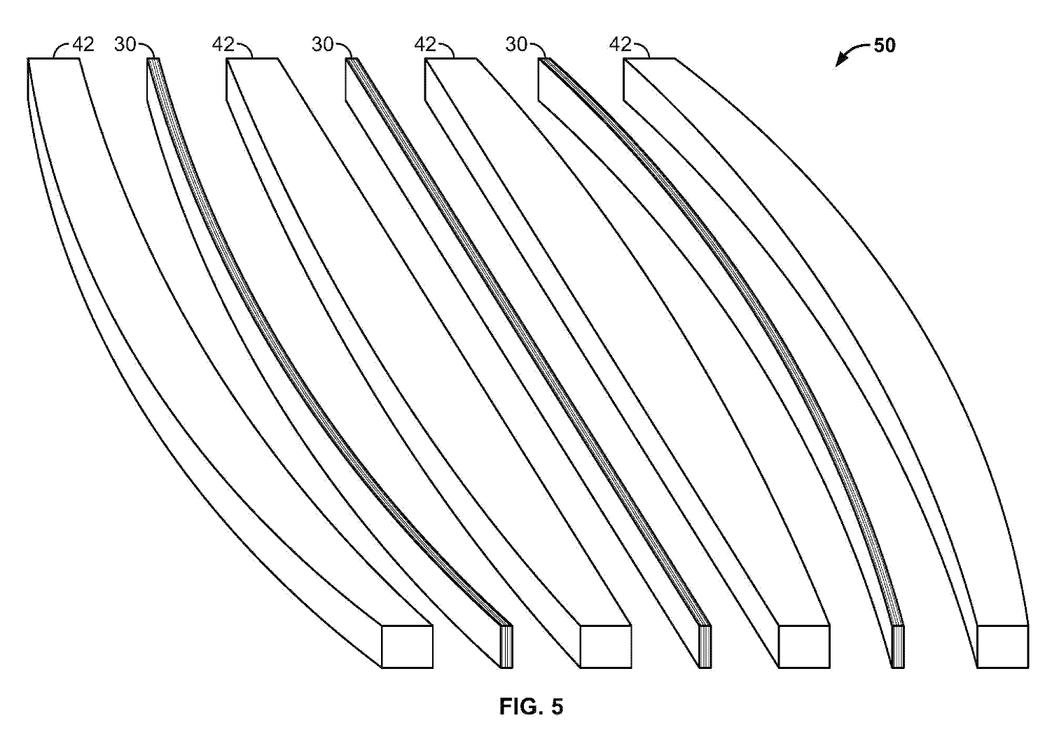

Now referring to FIG. 5, an alternate sports board stringer system is shown with a stringer system in multiple locations of the sports board. Stringer system 50 comprises multiple stringer systems 30 in various locations of the board. Here, stringers 30 may concentrate toward the center of the board inside blank 42. Additionally, stringers 30 may outline the perimeters of the board along the rails. This is usually done if blank 42 is constructed of a stronger material than foam, such as a carbon fiber board. In alternate embodiments, different layouts of stringer system 30 could be used in various locations of the board. The presently described stringer system is perfect for use in a wide range of sports boards, not limited to surfboards, body boards, windsurfing boards, kite boards, knee boards, skim boards, skateboards, snowboards and even skis.

The present invention includes any novel feature or combination of features disclosed herein either explicitly or any generalization thereof. While the invention has been described with respect to specific examples including presently preferred modes of carrying out the invention, those skilled in the art will appreciate that there are numerous variations and permutations of the above described apparatus and techniques. Thus, the spirit and scope of the invention should be construed broadly as set forth in the appended claims.

What is claimed is:

1. A stringer system for a sports board comprising:
a multi-layered strip of random, non-woven, thermoplastic web fiber composite bonded together by a resin.

2. The device of claim 1, further comprising a layout formed by various lengths of said strip bonded together.

3. The device of claim 1, further comprising an additional material bonded within said strip by said resin.

4. The device of claim 3, wherein said additional material is wood.

5. The device of claim 3, further comprising a layout formed by various lengths of said strip bonded together.

6. The device of claim 3, wherein said resin permeates within said strip during the manufacturing process.

7. A sports board comprising:
a stringer system further comprising a multi-layered strip of random, non-woven, thermoplastic web fiber composite material bonded together by a resin, and
a blank attached around said stringer system.

8. The device of claim 7, wherein said blank is attached by glue.

9. The device of claim 7, wherein said blank is attached through holes that are predrilled into said blank.

10. The device of claim 7, wherein said blank is attached using a vacuum process technique.

11. The device of claim 7, further comprising a layout formed by various lengths of said strip bonded together.

12. The device of claim 7, further comprising an additional material bonded within said strip by said resin.

13. The device of claim 12, wherein said additional material is wood.

14. The device of claim 12, further comprising a layout formed by various lengths of said strip bonded together.

15. The device of claim 14, further comprising multiple stringer systems arranged inside said blank.

16. The device of claim 14, wherein said resin permeates within said strip during the manufacturing process.

17. A precursor product of a stringer system comprising:
a multi-layered sheet of random, non-woven thermoplastic web fiber composite material bonded together by a resin.

18. The device of claim 17, wherein said composite material is formed through a thermal bonding process.

19. The device of claim 17, wherein said composite material is spunbonded.

20. The device of claim 17, wherein said fiber within said composite material and fiber properties are uniform along all axis of any particular strip of said material.
